(19) United States
(12) Patent Application Publication
(10) Pub. No.: US 2016/0214329 A1
(43) Pub. Date: Jul. 28, 2016

(54) METHOD OF FORMING A COMPOSITE MEMBER AND ASSEMBLY THEREFOR

(71) Applicant: BOMBARDIER INC., Montréal (CA)

(72) Inventors: Louis FERNANDES, Laval (CA); Marc LEMIEUX, Laval (CA); Youenn EURY, Pierrefonds (CA); Abdelatif ATARSIA, Montreal (CA)

(73) Assignee: Bombardier Inc., Dorval, QC (CA)

(21) Appl. No.: 14/917,675

(22) PCT Filed: Sep. 10, 2014
(86) PCT No.: PCT/IB2014/064400

§ 371 Date: Mar. 9, 2016

Related U.S. Application Data
(60) Provisional application No. 61/876,016, filed on Sep. 10, 2013.

(51) Int. Cl. B29C 70/34; B29C 65/00; B29C 65/48

(52) U.S. Cl. CPC B29C 70/342; B29C 65/481; B29C 66/63; B29C 66/5326; B29L 2022/00

(57) ABSTRACT

A method of preparing a composite element for forming a composite assembly having a cavity is disclosed. The method includes laying a barrier layer on a surface of the composite element which defines at least part of the cavity. A support assembly including a mandrel (38) and a film bag (40) extending on the surface of the mandrel is positioned with the film bag against the barrier layer. A sealed enclosure containing the composite element is formed through sealing engagement with the film bag. The pressure within the sealed enclosure is reduced, and the mandrel is separated from the film bag while maintaining the film bag positioned against the barrier layer. In one embodiment, the element is a stringer and is positioned against a skin. An assembly for forming a composite member is also provided.

### CROSS-REFERENCE TO RELATED APPLICATIONS

This application claims priority from U.S. provisional application No. 61/876,016 filed Sep. 10, 2013, the entire contents of which are incorporated by reference herein.

### FIELD OF THE APPLICATION

The present application relates generally to the manufacture of composite components, and more particularly to such elements having an elongated cavity defined therein.

### BACKGROUND OF THE ART

Composite components having an elongated cavity defined therein are usually manufactured from two or more elements assembled together while at least one of the elements is not fully cured, around a mandrel having a shape corresponding to that of the cavity, and the assembled elements are typically cured with the mandrel maintaining the shape of the cavity.

WO2010/143212 discloses a method of manufacturing stiffened panels made from composite material using a support in the cavity, which may be removable. The support is wrapped in a series of layers, the first of which is an impermeable tubular film bag neatly closed around the support, over which a breather in form of a tubular bag is wrapped around the bag, over which a tubular separator is wrapped and sealed at its two ends. Vacuum is applied to the separator to make the assembly of layers adhere to the support. The support is placed in the stringer cavity when the uncured stringer and skin are assembled for curing. However, wrapping of the support in several successive tubular bags may require relatively complex manipulation and/or create an irregular surface for the wrapped support coming into contact with the surface of the stringer. As such, wrinkles or other surface flaws may be produced in the stringer surface in contact with the separator.

### SUMMARY OF THE APPLICATION

It is therefore an aim of the present disclosure to provide an improved method of and assembly for forming a composite member.

Therefore, in one aspect, there is provided a method of preparing a composite element to be used for forming a composite assembly having a longitudinally extending cavity, the method comprising: laying a barrier layer on a surface of the composite element, the surface defining at least part of the longitudinally extending cavity when the composite assembly is formed; positioning a support assembly against the barrier layer, the support assembly comprising a mandrel and a film bag extending on the surface of the mandrel so as to position the film bag against the barrier layer; forming a sealed enclosure containing the composite element through sealing engagement with the film bag; reducing pressure within the sealed enclosure; and separating the mandrel from the film bag while maintaining the film bag positioned against the barrier layer.

In a particular embodiment, the barrier layer is impermeable or substantially impermeable to a matrix material of the composite element. The barrier layer may include a polyvinyl fluoride film in contact with the surface of the composite element bonded to a mesh reinforcement ply in contact with the film bag. The barrier layer may include ethylene tetrafluoroethylene.

In a particular embodiment, the method further comprises adhering the barrier layer to the surface of the composite element.

In a particular embodiment, the method further comprises positioning a mold on a surface of the composite element opposite to the surface on which the barrier layer is laid.

In a particular embodiment, the composite element is uncured and has a stabilized geometry.

In a particular embodiment, separating the mandrel from the film bag includes removing the mandrel from the cavity, and the method further comprises curing the composite assembly after the mandrel is removed from the cavity.

In a particular embodiment, the mandrel has a shape complementary to that of the at least part of the cavity.

In a particular embodiment, the method further comprises assembling the composite element with a second composite element so as to form the composite assembly around the support assembly with the shape of the mandrel being complementary to that of the cavity, the cavity being defined by the combination of the composite element with the second composite element.

In a particular embodiment, the method further comprises disposing a second barrier layer between the second composite element and the support assembly. In a particular embodiment, the second barrier layer is applied to an outer surface of the film bag before the mandrel is received therein. The second barrier layer may include a polyvinyl fluoride film in contact with an inner surface of the second composite element bonded to a mesh reinforcement ply in contact with the film bag. The second barrier layer may include ethylene tetrafluoroethylene.

In a particular embodiment, the second composite element is uncured and has a stabilized geometry. The composite element may be a stringer, the second composite element a skin, and the composite assembly a stiffened panel.

In a particular embodiment, the method further comprises, before assembling the composite element with the second composite element, applying noodles of uncured material at a junction between the composite element and the second composite element, and wherein reducing the pressure within the sealed enclosure includes modifying a cross-sectional shape of each noodle.

In a particular embodiment, laying the barrier layer on the surface of the composite element includes: applying the barrier layer over and extending on each side of a protuberance defined in a surface of a male mold; applying a plurality of plies of composite material over the respective barrier layer to form the composite element having at least a portion conforming to the protuberance; forming a bag containing the composite element and the surface of the male mold and reducing a pressure within the bag; releasing the composite element from the bag and the male mold. The method may further comprise, before applying the plurality of plies, forming a bag containing the barrier layer and the surface of the male mold and reducing a pressure within the bag. The method may further comprise, at least once between the application of successive ones of the plies over the barrier layer, forming a bag containing the plies and the surface of the male mold and reducing a pressure within the bag.

In another aspect, there is provided a method of forming a composite panel including at least one stringer and a skin, the method comprising: for each of the at least one stringer: forming the stringer with a body portion extending between two foot portions, the body portion having a concave inner surface covered by a first barrier layer and defining a stringer cavity, and filling the stringer cavity with a respective mandrel received within a respective tubular bag by positioning the tubular bag against the first barrier layer; with each stringer cavity filled by the respective mandrel, contacting the foot portions of each stringer with the skin while preventing contact between the respective tubular bag and the skin with a second barrier layer; forming a sealed enclosure containing the skin and each stringer through sealing engagement of an outer bag material with the respective tubular bag of each stringer; reducing pressure within the sealed enclosure; and removing the respective mandrel of each stringer from the respective tubular bag while maintaining the respective tubular bag positioned against the barrier layers.

In a particular embodiment, the method further comprises supporting an outer surface of each stringer with a stringer mold and supporting the skin with a skin mold.

In a particular embodiment, the method further comprises, after the respective mandrel of each stringer is removed from the respective tubular bag, heating the composite panel to cure the at least one stringer and/or the skin while maintaining the sealed enclosure under reduced pressure.

For each stringer, the second barrier may be applied to a surface of the respective tubular bag before the respective mandrel is received therein.

In a further aspect, there is provided an assembly for forming a composite member having a longitudinal cavity defined therein, the assembly comprising: at least two complementary composite elements in direct contact with one another with at least one of the composite elements being in an uncured state, each of the elements having an inner surface defining part of a surface of the cavity and an opposed outer surface, the inner surface of each of the elements being covered by a respective barrier layer; a support assembly received in the cavity including a mandrel received in a tubular bag with contact between the tubular bag and the inner surface of each of the elements being prevented by the respective barrier layer, the mandrel having a cross-sectional shape complementary to that of the cavity and being removable from the tubular bag; and bagging material in sealing engagement with the tubular bag and defining therewith a sealed cavity containing the elements; wherein the mandrel remains removable from the tubular bag when the sealed cavity is under reduced pressure with respect to a surrounding environment.

In a particular embodiment, the barrier layers are free to move relative to one another.

In a particular embodiment, the assembly further comprises a respective mold supporting the outer surface of each of the elements.

In a particular embodiment, the at least two complementary elements include a skin and a stringer, the respective barrier layer of the stringer being adhered to the inner surface thereof. The respective barrier layer of the skin may be adhered to a surface of the tubular bag.

In a particular embodiment, at least one of the respective barrier layers includes a polyvinyl fluoride film connected to a mesh reinforcement ply.

In a particular embodiment, at least one of the respective barrier layers includes ethylene tetrafluoroethylene.

In a particular embodiment, the mandrel is made of foam.

### BRIEF DESCRIPTION OF DRAWINGS

For a better understanding of the present invention, as well as other aspects and further features thereof, reference is made to the following description which is to be used in conjunction with the accompanying drawings, where:

FIG. 1 is a schematic isometric view of an aircraft;

FIG. 2 is a schematic cross-sectional view of a composite panel according to a particular embodiment, which can be used in an aircraft such as shown in FIG. 1; and

FIGS. 3 to 9 are schematic cross-sectional views of steps in the assembly of the composite panel of FIG. 2 in accordance with a particular embodiment, with FIG. 3A showing a detail of FIG. 3 and FIG. 7A showing a detail of FIG. 7.

In the drawings, embodiments of the invention are illustrated by way of example. It is to be expressly understood that the description and drawings are only for purposes of illustration and as an aid to understanding. They are not intended to be a definition of the limits of the invention.

### DESCRIPTION OF PREFERRED EMBODIMENTS

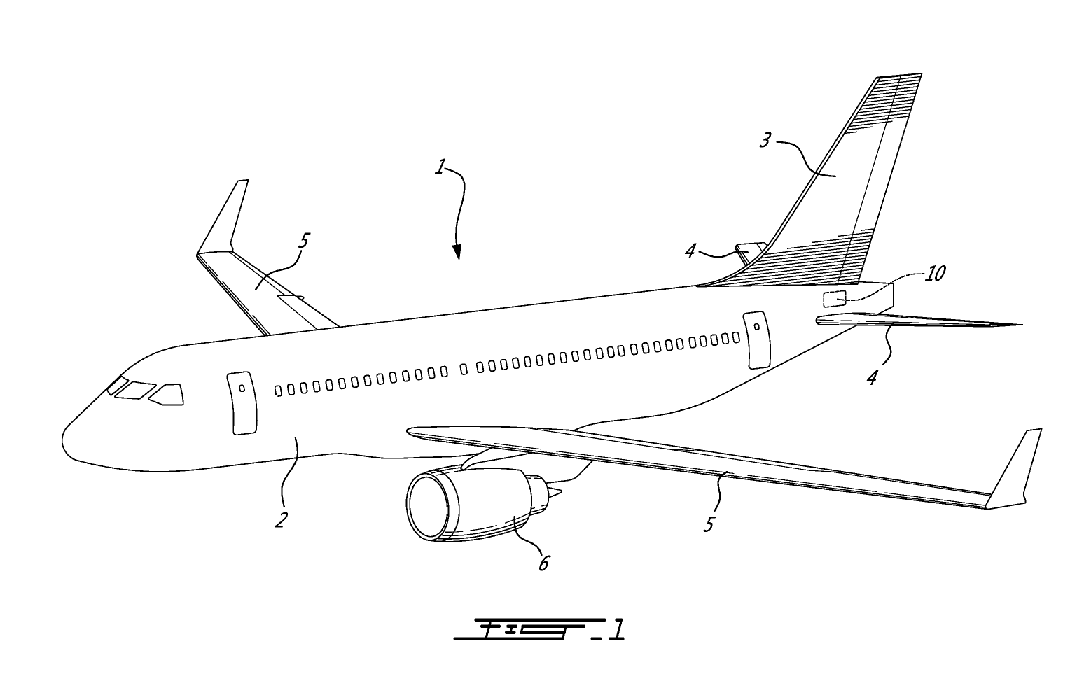

Referring to the drawings and more particularly to FIG. 1, an aircraft is shown at 1, and is generally described to illustrate some components for reference purposes in the present disclosure. The aircraft 1 has a fuselage 2 having a fore end at which a cockpit is located, and an aft end supporting a tail assembly, with the cabin generally located between the cockpit and the tail assembly. The tail assembly comprises a vertical stabilizer 3 with a rudder, and horizontal stabilizers 4 with elevators. The tail assembly has a fuselage-mounted tail, but other configurations may also be used for the aircraft 1, such as cruciform, T-tail, etc. Wings 5 project laterally from the fuselage. The aircraft 1 has engines 6 supported by the wings 5, although the engines 6 could also be mounted to the fuselage 2. The aircraft 1 is shown as a jet-engine aircraft, but may also be a propeller aircraft.

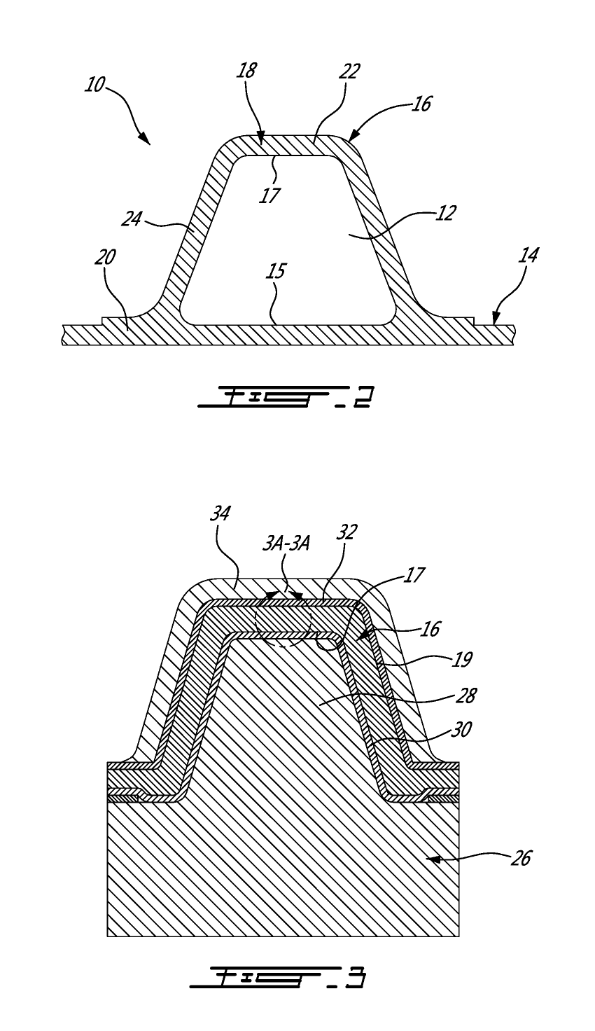

Referring to FIG. 2, a composite member 10 having a longitudinal cavity 12 defined therein, and formed from at least two interconnected elements 14, 16 each having an inner surface 15, 17 defining a corresponding part of a surface of the cavity 12, is shown. In this particular embodiment, the composite member 10 is part of a panel, and the elements include a skin 14 and a stringer 16. The stringer 16 includes a body portion 18 extending between two foot portions 20. Each foot portion 20 extends along the skin 14 and is connected thereto. The body portion 18 is spaced apart from the skin 14 to define the stringer cavity 12. In the embodiment shown the stringer 16 has an omega (0) shape, with the body portion 18 including a central wall 22 extending parallel to or along the general direction of the skin 14, and angled side walls 24 extending from the central wall 22 to the foot portions 20, with a distance between the side walls 24 progressively increasing from the central wall 22 to the foot portions 20.

Although the stringer 16 shown has an omega shaped cross-section, other cross-sectional shapes are also possible, including, but not limited to, delta-shaped (Δ) cross-sections.

In a particular embodiment, the skin 14 is curved and the composite panel 10 defines a section of the fuselage 2. In another embodiment, the skin 14 and composite panel 10 are flat. The composite panel 10 may define part of an internal bulkhead, part of the wing 5, or any other appropriate structural element of the aircraft 1. Although a single stringer 16 is shown, it is understood that the composite panel 10 may and typically does include a plurality of stringers 16 spaced apart from one another. In a particular embodiment, the stringer 16 extends longitudinally along only part of a corresponding dimension of the skin 14, i.e. the skin 14 extends in the longitudinal direction beyond the stringer 16. In another embodiment, the stringer 16 extends longitudinally along the entire corresponding dimension of the skin 14.

Each element is formed with composite material, at least one of which being uncured with a stabilized geometry, i.e. having a matrix with a reduced viscosity without having been heated to the temperature point where polymerization typically starts (e.g., prepreg); one or more of the elements may be cured, such that curing of the uncured element(s) assembled to the cured element(s) provides for a co-bonding of the elements. For example, the elements may include one or more uncured stringer(s) and a cured skin, or an uncured skin and one or more cured stringer(s). In the particular embodiment described herein, the elements include the skin and stringer(s) 14, 16 which are both uncured with a stabilized geometry, such as to be co-cured after assembly as described below.

Although the method is described herein with specific reference to a stringer and skin assembly, it is understood that a similar method can be applied to any member formed from composite elements to be co-cured with a cavity being defined between the elements. Non limiting examples include nautical hollow composite members such as masts and booms, hollow blades (e.g. rotor blades, fan blades, etc.), sports equipment having hollow bodies such as rackets, bicycle frames and hockey sticks, etc.

Referring to FIG. 3, in a particular embodiment, the stringer 16 is assembled from plies of prepreg (pre-impregnated) composite material including fibers, for example weaved or unidirectional fibers, bonded by a matrix material having a stabilized geometry to facilitate handling, such that the matrix material becomes solid yet remains flexible and tacky. In a particular embodiment, the matrix material is a B-stage resin; any other appropriate alternate type of thermoset or thermoplastic matrix material may be used, including but not limited to bismaleimide resin (BMI), phenolic resin, and polyvinyl ester. The skin 14 is similarly assembled from plies of prepreg material. In a particular embodiment, both the skin and stringer 14, 16 are formed of carbon fiber embedded in an epoxy resin material. Alternate fiber materials which may be used include, but are not limited to, glass and para-aramid (Kevlar®) fibers, which may be provided in any appropriate form including but not limited to weave, non-crimp fabric (NCF) and bi-directional orientation. The skin 14 and/or stringer 16 may alternately be formed using any other adequate method, including but not limited to vacuum assisted resin infusion in conjunction with a dry preform.

As shown in FIG. 3, in a particular embodiment, the stringer 16 is formed using a male mold 26 with a protuberance 28 having a shape complementary to that of the stringer cavity 12. The male mold 26 is adequately prepared before use, including for example covering vacuum port(s) defined therein with mesh material and breather material.

A barrier layer 30 which in a particular embodiment is impermeable or substantially impermeable to the matrix material of the composite (i.e. preventing or substantially preventing the matrix material from flowing therethrough during cure and releasable from the composite material after cure) is first applied over the protuberance 28 of the mold 26 such as to extend on each side thereof. The barrier layer 30 is applied in a smooth manner, such as to avoid or limit the formation of wrinkles in the stringer's inner surface 17. In an embodiment where the inner surface 17 must have a smooth finish after cure, the surface of the barrier layer 30 in contact with the inner surface 17 is correspondingly smooth. In a particular embodiment, the barrier layer 30 is formed of two or more plies adhered to one another, for example, as shown in FIG. 3A, a reinforcement ply 30a in contact with the mold 26 and a release film 30b impermeable or substantially impermeable to the matrix material superposed and adhered to the reinforcement ply 30a. In a particular embodiment, the release film 30b is a polyvinyl fluoride (PVF) film, such as Tedlar®, and the reinforcement ply 30a is a peel ply made of nylon mesh. In another embodiment, the barrier layer 30 is formed by a single ply of material impermeable or substantially impermeable to the matrix material, for example a single ply of ethylene tetrafluoroethylene (ETFE) film. Alternate materials which can form the barrier layer 30 include, but are not limited to, two or more plies of ethylene tetrafluoroethylene (ETFE), nylon tape, other types of release film, polytetrafluoroethylene (Teflon®), and combinations thereof or of any other adequate material providing a similar degree of rigidity.

In the embodiment shown, plies 16a (see FIG. 3A) of prepreg material are then applied over the barrier layer 30 until a desired stringer thickness is reached. Appropriate tools are used to conform each ply 16a to the contour defined by the protuberance 28 of the mold 26 while avoiding the formation of wrinkles or bubbles in the ply 16a.

Once all the plies 16a are applied, and in a particular embodiment at intervals during application of the plies 16a, a bag (not shown) is formed to enclose the stringer 16 and the surface of the mold 26, for example by engaging bagging material with any appropriate type of sealing material (e.g. tacky compound, double faced tape) applied on the mold surface and defining a perimeter around the stringer 16, and the bag is put under vacuum or negative pressure (i.e. reduced pressure with respect to that of the surrounding environment) using an appropriate vacuum system to compact the plies 16a. In a particular embodiment, the bag is formed and is put under reduced pressure between the application of the barrier layer 30 and of the first ply 16a of composite material, and at regular intervals during application of the plies 16a, for example after the application of every second ply.

In a particular embodiment, the mold 26 is heated during the application of the first ply 16a, with the heat source being turned off when the other plies 16a are applied and when the plies 16a are bagged and the pressure in the bag is reduced during the process of applying the plies 16a as mentioned above. In an alternate embodiment, the mold 26 is heated during the application of each ply 16a and the heat source is turned off during bagging and pressurization of the plies 16a. In a particular embodiment, after the application of the last ply, the stringer 16 is bagged and kept under reduced pressure while being heated for a final compaction. After the assembled stringer 16 has been compacted, the bagging material is removed.

The stringer may alternately be formed and engaged to the barrier layer 30 using any other appropriate method, for example by laying plies of dry preform over the barrier layer 30 and performing vacuum assisted infusion to apply the binder to the plies.

Still referring to FIG. 3, in a particular embodiment, a release film 32 is then applied over the outer surface 19 of the stringer 16, and a female mold 34 is engaged to the outer surface 19 with the release film 32 extending therebetween. If trimming is required, the female mold 34 may be heated to a temperature lower than the cure temperature to facilitate trimming, and excess material from the plies 16a may be trimmed, for example after the heat source has been turned off.

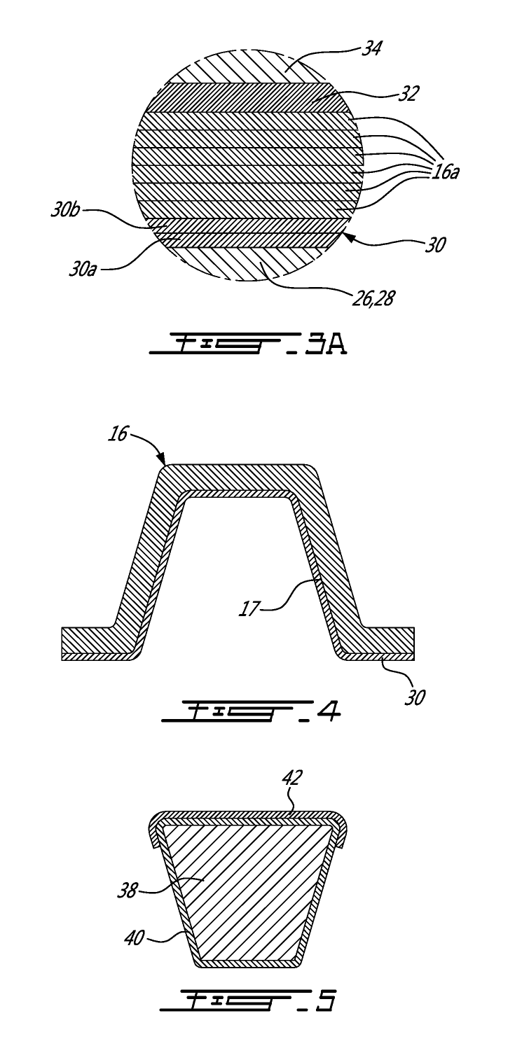

Referring to FIG. 4, the stringer 16 is then released from the molds 26, 34 and the outer release film 32 is removed, such that the stringer 16 remains with the barrier layer 30 covering its inner surface 17.

Referring to FIG. 6, the stringer 16 with its inner surface 17 covered by the barrier layer 30 is installed with its outer surface 19 in contact with a stringer mold 36, the body portion 18 of the stringer being received in a corresponding cavity of the mold 36. It is understood that in the present specification the term “mold” is intended to encompass any tool having a shape-defining surface configured to control a surface of the element during curing of the assembly, having any appropriate thickness, and designed to control the inner mold line (IML) or outer mold line (OML) surface of the element, including, but not limited to, pressure pads typically referred to as caul plates.

The stringer mold 36 is adequately treated before receiving the stringer 16; for example, in a particular embodiment, a sealant and a mold release material are applied to the mold 36 before the stringer 16 is received therein. The part of the barrier layer 30 covering the foot portions 20 is folded in the stringer cavity, such as to expose the inner surface of the foot portions 20. A bag (not shown) is formed to enclose the stringer and the surface of the mold 36, for example by engaging bagging material with a sealing material (e.g. tacky compound, double faced tape) applied on the surface of the mold 36 and defining a perimeter around the stringer 16, and the pressure in the bag is reduced for a predetermined period of time using an appropriate vacuum system to compact the stringer 16 against the mold. In a particular embodiment, the pressure reduction is applied in two or more incremental steps between which the bag is manually positioned to minimize wrinkling.

Still referring to FIG. 6, the bagging material is removed and the stringer cavity is then filled with a support assembly including a mandrel 38, for example made of foam, received in a tubular film bag 40 and having a shape complementary to that of the cavity 12 in the composite member 10. The mandrel 38 is removable from the bag 40, for example through an open end thereof. In a particular embodiment, the mandrel 38 is made of a low density polyurethane foam. Alternately, any other material offering a low density, flexibility and appropriate shape memory may be used. In a particular embodiment, the tubular bag 40 is extruded, or co-extruded if made of more than one material, with a wall forming a continuous perimeter. Alternate methods which may be used to manufacture the bag 40 include, but are not limited to, welding of the film material. In a particular embodiment, the bag 40 is co-extruded with an inner layer of nylon and an outer layer of ethylene tetrafluoroethylene (ETFE).

A second barrier layer 42, which in a particular embodiment is impermeable or substantially impermeable to the matrix material, extends over the portion of the tubular bag 40 exposed between the two foot portions 20 and not covered by the first barrier layer 30. The first and second barrier layers 30, 42 are movable relative to one another, which in a particular embodiment avoids or reduces constraining of the tubular bag 40. The tubular bag 40 and mandrel 38 extend longitudinally beyond the mold 36, as will be further detailed below.

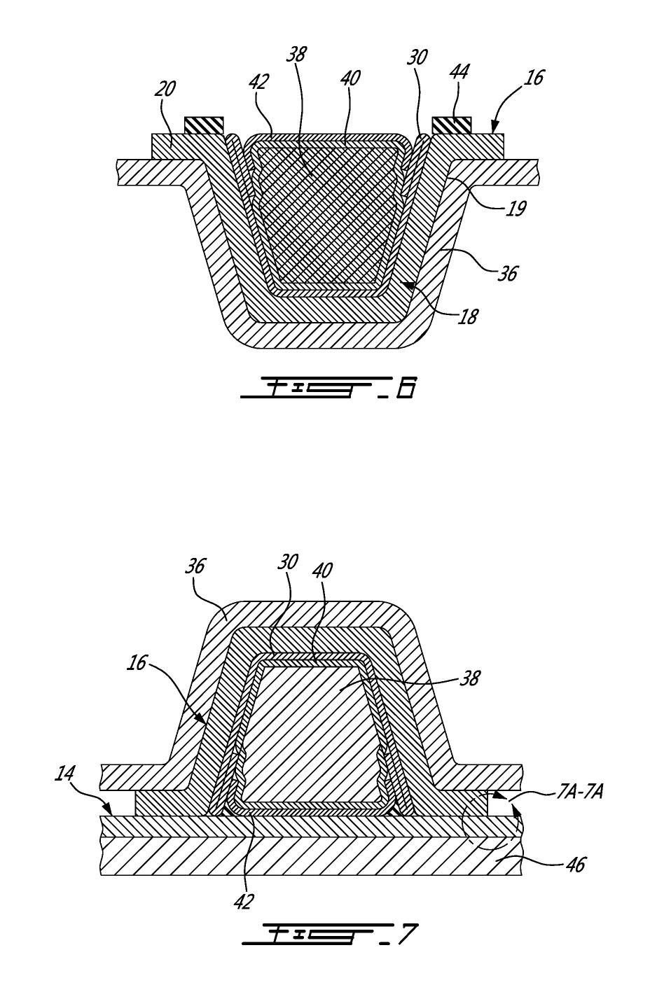

In a particular embodiment, and as shown in FIG. 5, the second barrier layer 42 is adhered to the surface of the empty tubular bag 40, and the mandrel 38 is then inserted within the tubular bag 40. The second barrier layer 42 may be provided in the form of a tape. In a particular embodiment, the second barrier layer 42 is formed of a tape of ethylene tetrafluoroethylene (ETFE). Alternately, the second barrier layer 42 may include a reinforcement ply in contact with the tubular bag and a release film over the reinforcement ply, similarly to the first barrier layer 30, and/or may be provided attached to the skin 14. Alternate embodiments are also possible, including all alternate materials described for barrier layer 30 above, including, but not limited to, polytetrafluoroethylene (Teflon®).

Referring back to FIG. 6, structural reinforcements in the form of noodles 44 of uncured material are installed over part of the foot portions 20 adjacent the junction between the foot portions 20 and the body portion 18. In a particular embodiment, the noodles 44 are installed while having an initial cross-section different from their cross-section in the cured composite member 10; for example, the noodles 44 are installed while having a rectangular cross-section which deforms during pressurization and/or cure to conform to the profile of the junction between the foot portion 20 and the body portion 18. In a particular embodiment, the noodles 44 are made of a composite material including fiberglass received in an epoxy resin. Alternate materials which may be used for the noodles 44 include, but are not limited to, any material compatible with the resin used for the elements (skin 14 and stringer 16), which may include short fibers, surfacing film, adhesive film, foam adhesive, unidirectional or weaved carbon, glass or para-aramid synthetic (Kevlar®) fibers, etc.

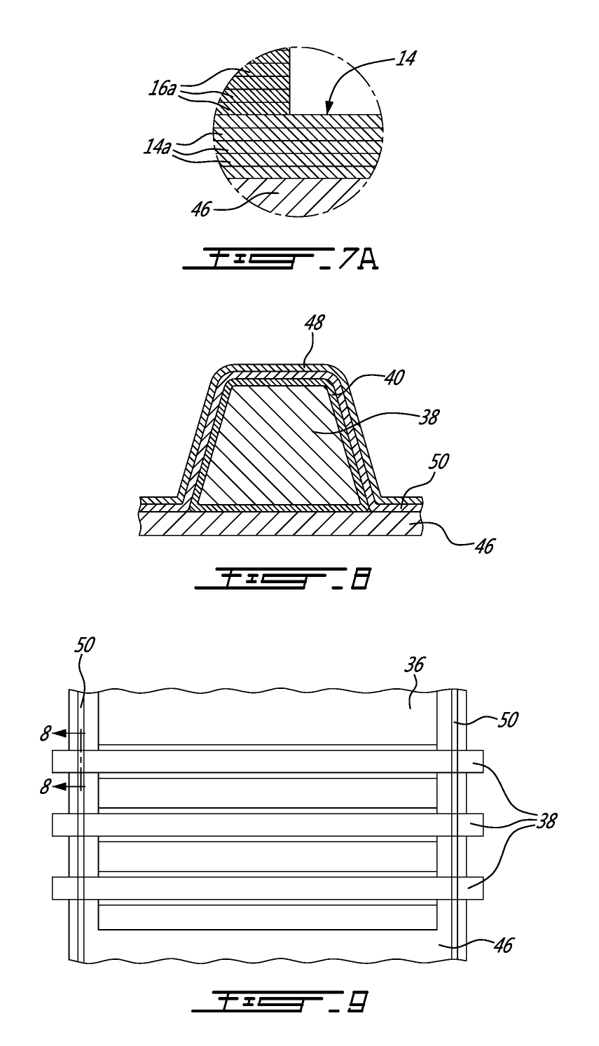

Referring to FIGS. 7-7A, the skin 14, for example made of a plurality of superposed plies 14a of prepreg materials, is compacted on a surface of a mold 46, for example through a bagging and vacuum process similar to that described above for the stringer 16. The two molds 36, 46 are brought together such that the foot portions 20 of the stringer 16 are in direct contact with the skin 14, with the second barrier layer 42 preventing direct contact between the tubular bag 40 and the skin 14. The noodles 44 are partly compressed between the stringer 16 and the skin 14. The skin mold 46 extends longitudinally beyond the stringer mold 36, as can be seen in FIG. 9.

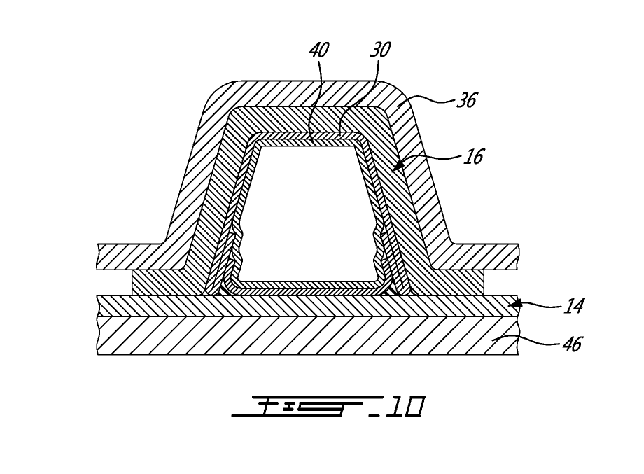

Referring to FIGS. 8-9, the assembly is bagged for curing. Breather material and release film (not shown) are installed as required; for example, in a particular embodiment, breather material is provided where the molds 36, 46 would otherwise be in direct contact with one another, over the vacuum ports, between the skin mold 46 and the portions of the tubular bags 40 extending beyond the stringer mold 36, etc., and a release film and breather material are installed over the stringer mold 36 and exposed skin 14 to prevent direct contact thereof with the bagging material 48 forming the cure bag. Additional elements may be provided to the assembly before bagging; for example structural inserts, mesh material, etc. which form part of the skin 14 and/or the stringer 16 in the cured composite panel 10 are applied over the uncured skin 14 and/or stringer 16, before or after the molds 36, 46 are assembled.

The bagging material 48 encloses the stringer mold 36 and the skin 14 and is in sealing engagement with the skin mold 46 and with the tubular bag 40 such as to define a sealed cavity containing the stringer 16 and skin 14. In the embodiment shown, this is achieved by engaging the bagging material 48 with a sealing material 50 (e.g. tacky compound, double faced tape) applied on the surface of the skin mold 46 and around each tubular bag 40 spaced apart from the stringer mold 36, such as to define a perimeter around the stringer mold 36. The pressure in the sealed cavity is reduced using an appropriate vacuum system.

Once the sealed cavity is under vacuum or reduced pressure, the mandrel 38 is removed from the tubular bag 40 through the open end. The final assembly free of the mandrel, which in a particular embodiment is as shown in FIG. 10, is ready for curing, for example in an autoclave. In a particular embodiment, the pressure in the sealed cavity is further reduced once the mandrel 38 is removed.

In a particular embodiment, the mandrel 38 allows for the cavity 12 to maintain its shape during the assembly, bagging and pressurizing process, and the mandrel 38 being removed before curing may allow for cheaper materials to be used to manufacture the mandrel 38 and/or facilitate re-use of the mandrels 38 for other assemblies. In a particular embodiment, the relatively movable barrier layers 30, 42 cooperating to surround the tubular bag 40 and to prevent direct contact between the composite material and the tubular bag 40 may reduce surface flaws on the surface of the cavity 12, allowing for a better surface quality than that which would be produced with the composite material in direct contact with the tubular bag 40 or with a tubular release film surrounding the tubular bag 40. The formation of at least one of the elements (for example, the stringer 16) directly on the barrier layer may allow for a smoother surface finish for that element, reducing the risk of wrinkles or other texture being formed at the interface between the element and the barrier layer.

As mentioned above, although the method has been described with specific reference to a stringer and skin assembly, it can be applied to any member formed from composite elements to be co-cured with a cavity being defined between the elements.

While the methods and systems described herein have been described and shown with reference to particular steps performed in a particular order, it will be understood that these steps may be combined, subdivided or reordered to form an equivalent method without departing from the teachings of the present invention. Accordingly, the order and grouping of the steps is not a limitation of the present invention.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

1. A method of preparing a composite element to be used for forming a composite assembly having a longitudinally extending cavity, the method comprising:
laying a barrier layer on a surface of the composite element, the surface defining at least part of the longitudinally extending cavity when the composite assembly is formed;
positioning a support assembly against the barrier layer, the support assembly comprising a mandrel and a film bag extending on the surface of the mandrel so as to position the film bag against the barrier layer;
forming a sealed enclosure containing the composite element through sealing engagement with the film bag;
reducing a pressure within the sealed enclosure; and
separating the mandrel from the film bag while maintaining the film bag positioned against the barrier layer.

2. The method as defined in claim 1, wherein the barrier layer is impermeable or substantially impermeable to a matrix material of the composite element.

3. The method as defined in claim 1, further comprising adhering the barrier layer to the surface of the composite element.

4. The method as defined in claim 1, further comprising positioning a mold on a surface of the composite element opposite to the surface on which the barrier layer is laid.

5. The method as defined in claim 1, wherein the composite element is uncured and has a stabilized geometry.

6. The method as defined in claim 1, wherein separating the mandrel from the film bag includes removing the mandrel from the cavity, the method further comprising curing the composite assembly after the mandrel is removed from the cavity.

7. The method as defined in claim 1, wherein the barrier layer includes a polyvinyl fluoride film in contact with the surface of the composite element bonded to a mesh reinforcement ply in contact with the film bag.

8. The method as defined in claim 1, wherein the barrier layer includes ethylene tetrafluoroethylene.

9. The method as defined in claim 1, wherein the mandrel has a shape complementary to that of the at least part of the cavity.

10. The method as defined in claim 1, further comprising assembling the composite element with a second composite element so as to form the composite assembly around the support assembly with the shape of the mandrel being complementary to that of the cavity, the cavity being defined by the combination of the composite element with the second composite element.

11. The method as defined in claim 10, further comprising disposing a second barrier layer between the second composite element and the support assembly.

12. The method as defined in claim 11, wherein the second barrier layer is applied to an outer surface of the film bag before the mandrel is received therein.

13. The method as defined in claim 11, wherein the second barrier layer includes a polyvinyl fluoride film in contact with an inner surface of the second composite element bonded to a mesh reinforcement ply in contact with the film bag.

14. The method as defined in claim 11, wherein the second barrier layer includes ethylene tetrafluoroethylene.

15. The method as defined in claim 10, wherein the second composite element is uncured and has a stabilized geometry.

16. The method as defined in claim 10, further comprising, before assembling the composite element with the second composite element, applying noodles of uncured material at a junction between the composite element and the second composite element, and wherein reducing the pressure within the sealed enclosure includes modifying a cross-sectional shape of each noodle.

17. The method as defined in claim 10, wherein the composite element is a stringer, the second composite element is a skin and the composite assembly is a stiffened panel.

18. The method as defined in claim 1, wherein laying the barrier layer on the surface of the composite element includes:
applying the barrier layer over and extending on each side of a protuberance defined in a surface of a male mold;
applying a plurality of plies of composite material over the respective barrier layer to form the composite element having at least a portion conforming to the protuberance;
forming a bag containing the composite element and the surface of the male mold and reducing a pressure within the bag;
releasing the composite element from the bag and the male mold.

19. The method as defined in claim 18, further comprising, before applying the plurality of plies, forming a bag containing the barrier layer and the surface of the male mold and reducing a pressure within the bag.

20. The method as defined in claim 18, further comprising, at least once between the application of successive ones of the plies over the barrier layer, forming a bag containing the plies and the surface of the male mold and reducing a pressure within the bag.

21. A method of forming a composite panel including at least one stringer and a skin, the method comprising:
for each of the at least one stringer:
forming the stringer with a body portion extending between two foot portions, the body portion having a concave inner surface covered by a first barrier layer and defining a stringer cavity, and
filling the stringer cavity with a respective mandrel received within a respective tubular bag by positioning the tubular bag against the first barrier layer;
with each stringer cavity filled by the respective mandrel, contacting the foot portions of each stringer with the skin while preventing contact between the respective tubular bag and the skin with a second barrier layer;
forming a sealed enclosure containing the skin and each stringer through sealing engagement of an outer bag material with the respective tubular bag of each stringer;
reducing a pressure within the sealed enclosure; and
removing the respective mandrel of each stringer from the respective tubular bag while maintaining the respective tubular bag positioned against the barrier layers.

22-24. (canceled)

25. An assembly for forming a composite member having a longitudinal cavity defined therein, the assembly comprising:
at least two complementary composite elements in direct contact with one another with at least one of the composite elements being in an uncured state, each of the elements having an inner surface defining part of a surface of the cavity and an opposed outer surface, the inner surface of each of the elements being covered by a respective barrier layer;
a support assembly received in the cavity including a mandrel received in a tubular bag with contact between the tubular bag and the inner surface of each of the elements being prevented by the respective barrier layer, the mandrel having a cross-sectional shape complementary to that of the cavity and being removable from the tubular bag; and
bagging material in sealing engagement with the tubular bag and defining therewith a sealed cavity containing the elements;
wherein the mandrel remains removable from the tubular bag when the sealed cavity is under reduced pressure with respect to a surrounding environment.

26-32. (canceled)
